(19) United States
(12) Patent Application Publication
(10) Pub. No.: US 2025/0070215 A1
(43) Pub. Date: Feb. 27, 2025

(54) ELECTRODE ASSEMBLY FOR SECONDARY BATTERY

(71) Applicant: Samsung SDI Co., Ltd., Yongin-si (KR)

(72) Inventors: Hyung Dong LEE, Yongin-si (KR); Jae Hyung KIM, Yongin-si (KR); Seung Il KIM, Yongin-si (KR)

(21) Appl. No.: 18/639,884

(22) Filed: Apr. 18, 2024

(30) Foreign Application Priority Data
Aug. 24, 2023 (KR) 10-2023-0111184

(51) Int. Cl. H01M 10/04; H01M 50/538

(52) U.S. Cl. CPC H01M 10/0431; H01M 50/538

(57) ABSTRACT

An electrode assembly for a secondary battery includes positive and negative electrode plates and a separator therebetween. Each of the electrode plates includes: an electrode current collector plate and having an electrode active material layer on a surface of the electrode current collector plate and at least one uncoated portion at where no electrode active material is applied; and a plurality of electrode tabs electrically attached and coupled to the uncoated portions. The positive electrode tabs protrude upwardly from an upper portion of the electrode assembly, and the negative electrode tabs protrude downwardly from a lower portion of the electrode assembly.

### CROSS-REFERENCE TO RELATED APPLICATION

The present application claims priority to and the benefit of Korean Patent Application No. 10-2023-0111184, filed on Aug. 24, 2023, in the Korean Intellectual Property Office, the entire disclosure of which is incorporated herein by reference.

### BACKGROUND

### 1. Field

Aspects of embodiments of the present disclosure relate to an electrode assembly for a secondary battery.

### 2. Discussion of Related Art

Different from primary batteries, which are not designed to recharged, secondary batteries are batteries that are designed to be charged and discharged.

Low-capacity batteries which include a single battery cell are often used in small and portable electronic devices, such as mobile phones and camcorders. Large-capacity battery modules arrange din battery pack units in which dozens of battery modules are connected, are widely used as power sources for driving motors in hybrid vehicles, electric vehicles, and the like.

Lithium-ion batteries, which account for most of the secondary battery market, are generally divided into cylindrical, prismatic, and pouch batteries depending on their shape. As electronic devices become smaller, smaller batteries are required, and the demand for pouch-type secondary batteries is increasing. Pouch-type secondary batteries are manufactured in a flexible pouch-type secondary form such their shape is relatively moldable and their weight is relatively low, which is advantageous for slimming and reducing the weight of portable electronic devices. Recently, because the pouch-type secondary batteries provide superior space utilization compared to cylindrical or prismatic-type batteries, the pouch-type secondary batteries are being widely applied to middle-or large-sized batteries of electric vehicles. In such an application, to satisfy the high output requirements of hybrid vehicles or electric vehicles, the voltage of the battery pack is increased by connecting several pouch-type batteries together in series.

### SUMMARY

When a battery pack is formed by connecting a plurality of pouch-type battery cells in series, an electrode assembly for a secondary battery that has a structure allowing for stable and easy electrical connection between electrode tabs of adjacent battery cells is needed.

Embodiments of the present disclosure are directed to a secondary battery having an electrode assembly with an electrode tab structure in which two or more battery cell units can be connected to each other in series to provide high voltage and high output characteristics.

According to an embodiment of the present disclosure, an electrode assembly for a secondary battery includes: a positive electrode plate including: a positive electrode current collector plate and having a positive electrode active material layer on a surface of the positive electrode current collector plate and at least one uncoated portion at where no positive electrode active material is applied; and a plurality of positive electrode tabs electrically attached and coupled to the first uncoated portion; a negative electrode plate including: a negative electrode current collector plate and having a negative electrode active material layer on a surface of the negative electrode current collector plate and at least one uncoated portion at where no negative electrode active material is applied; and a plurality of negative electrode tabs electrically attached and coupled to the first uncoated portion; and a separator between the positive electrode plate and the negative electrode plate to insulate the positive and negative electrode plates from each other. The positive electrode tabs protrude upwardly from an upper portion of the electrode assembly, and the negative electrode tabs protrude downwardly from a lower portion of the electrode assembly.

The uncoated portions of the positive electrode plate may be provided at a winding start end and a winding finish end of the positive electrode plate in a winding direction, the uncoated portions of the negative electrode plate may be provided at a winding start end and a winding finish end of the negative electrode plate in a winding direction. A pair of the positive electrode tabs may be provided at the uncoated portion of the positive electrode plate at the winding start end of the positive electrode plate in the winding direction, and a pair of the negative electrode tabs may be provided at the uncoated portion of the negative electrode plate at the winding start end of the negative electrode plate in the winding direction.

The uncoated portions may be provided at a winding start end and a winding finish end of the positive electrode plate in a winding direction, and the uncoated portions may be provided at a winding start end and a winding finish end of the negative electrode plate in a winding direction. A pair of the positive electrode tabs may be provided at the uncoated portion of the positive electrode plate at the winding finish end of the positive electrode plate in the winding direction, and a pair of the negative electrode tabs may be provided at the uncoated portion of the negative electrode plate at the winding finish end of the negative electrode plate in the winding direction.

The uncoated portions may be provided at a winding start end and a winding finish end of the positive electrode plate in a winding direction, and the uncoated portions may be provided at a winding start end and a winding finish end of the negative electrode plate in a winding direction. The positive electrode tabs may be provided at the second uncoated portion of the positive electrode plate at the winding start end and the winding finish end of the positive electrode plate in the winding direction, and the negative electrode tabs may be provided at the uncoated portions of the negative electrode plate at the winding start end and the winding finish end of the negative electrode plate in the winding direction.

The uncoated portions may be provided at a winding start end, a winding finish end, and a center between the uncoated portions of the positive electrode plate in a winding direction, and the uncoated portions may be provided at a winding start end, a winding finish end, and a center between the uncoated portions of the negative electrode plate in a winding direction. The positive electrode tabs may be provided at the uncoated portion of the positive electrode plate at the winding start end and the center of the positive electrode plate in the winding direction, and the negative electrode tabs may be provided at the uncoated portion of the negative electrode plate at the winding start end and the center of the negative electrode plate in the winding direction.

The uncoated portions may be provided at a winding start end, a winding finish end, and a center between the uncoated portions of the positive electrode plate in a winding direction, and the uncoated portions may be provided at a winding start end, a winding finish end, and a center between the uncoated portions of the negative electrode plate in a winding direction. The positive electrode tabs may be provided at the uncoated portions of the positive electrode plate at the winding start end, the winding finish end, and the center of the positive electrode plate in the winding direction, and the negative electrode tabs may be provided at the uncoated portions of the negative electrode plate at the winding start end, the winding finish end, and the center of the negative electrode plate in the winding direction.

### BRIEF DESCRIPTION OF THE DRAWINGS

The above and other aspects and features of the present disclosure will become more apparent to those of ordinary skill in the art by describing, in detail, embodiments thereof with reference to the accompanying drawings, in which:

FIG. 1A is a perspective view illustrating an electrode assembly of a pouch-type secondary battery according to the related art before it is wound;

FIG. 1B is a perspective view illustrating the electrode assembly shown in FIG. 1A after it is wound;

FIG. 2A is a set of an exploded perspective view and a wound cross-sectional view of an electrode assembly according to an embodiment of the present disclosure;

FIG. 2B is a set of an exploded perspective view and a wound cross-sectional view of an electrode assembly according to another embodiment of the present disclosure;

FIGS. 3A and 3B are sets of an exploded perspective view and a wound cross-sectional view of an electrode assembly according to modified examples of the embodiments shown in FIGS. 2A and 2B, respectively;

FIG. 4 is a set of an exploded perspective view and a wound cross-sectional view of an electrode assembly according to another embodiment of the present disclosure;

FIG. 5A is a set of an exploded perspective view and a wound cross-sectional view of an electrode assembly according to another embodiment of the present disclosure;

FIG. 5B is a set of an exploded perspective view and a wound cross-sectional view of an electrode assembly according to another embodiment of the present disclosure;

FIGS. 5C and 5D are sets of an exploded perspective view and a wound cross-sectional view of an electrode assembly according to modified examples of the embodiments shown in FIG. 5A and 5B, respectively; and

FIG. 6 is a set of an exploded perspective view and a wound cross-sectional view of an electrode assembly according to another embodiment of the present disclosure.

### DETAILED DESCRIPTION

Hereinafter, embodiments of the present disclosure will be described, in detail, with reference to the accompanying drawings. Embodiments of the present disclosure are provided to more completely describe aspects and features of the present disclosure to those skilled in the art, and the following embodiments may be modified into various other forms. Accordingly, the scope of the present disclosure is not limited to the following embodiments. Rather, these embodiments are provided to fully convey the aspect and features of this disclosure to those skilled in the art.

In addition, in the following drawings, a thickness and a size of each layer are exaggerated for convenience and clarity of description, and the same reference numeral refers to the same component in the drawings. As used herein, the term “and/or” includes any one and all combinations of one or more of the listed items. In addition, the meaning of “connected” in the present specification refers not only to a case in which member A and member B are directly connected, but also to a case in which member C is interposed between member A and member B to indirectly connect member A and member B. Terms used herein are for the purpose of describing specific embodiments and are not intended to limit the present disclosure. As used herein, the singular form may include the plural form unless the context clearly indicates otherwise. In addition, when used herein, “comprise” and “include” and/or “comprising” and “including” specify the presence of stated shapes, numbers, steps, operations, members, elements, and/or groups thereof and does not exclude the presence or addition of one or more other shapes, numbers, steps, operations, members, elements, and/or groups thereof.

Although the terms first, second, and the like are used herein to describe various members, parts, regions, layers, and/or portions, it is obvious that these members, parts, regions, layers, and/or portions are not limited by these terms. These terms are used only to distinguish one member, part, region, layer, or portion from another member, part, region, layer, or portion. Thus, a first member, part, region, layer, or portion, which will be described in detail below, may refer to a second member, part, region, layer, or portion without departing from the teachings of the present disclosure.

As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

Spatially related terms such as “beneath,” “below,” “lower,” “above,” and “upper” may be used for easy understanding of an element or feature or other elements or features shown in the drawings. These spatially related terms are for easy understanding of the present disclosure according to various process states or usage states of the present disclosure and are not intended to limit the present disclosure. For example, when an element or feature of the drawing is flipped over, the element or feature described as “below” or “lower” becomes “above” or “upper.” Therefore, “below” is a concept encompassing “above” or “below.”

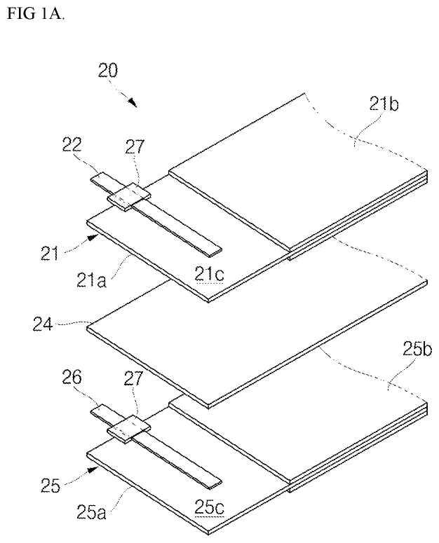

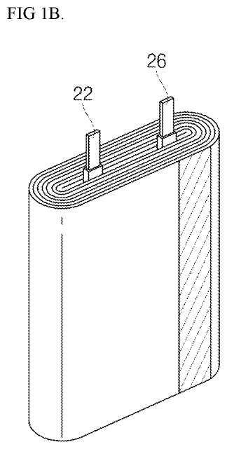

FIG. 1A is a perspective view of an electrode assembly of a pouch-type secondary battery according to the related art before it is wound, and FIG. 1B is a perspective view of the electrode assembly of FIG. 1A after it is wound. The pouch-type secondary battery includes an electrode assembly 20 and a pouch (not shown) for accommodating the electrode assembly, and FIGS. 1A and 1B show the electrode assembly accommodated in a pouch.

First, as shown in FIG. 1A, the electrode assembly 20 includes a positive electrode plate 21, a negative electrode plate 25, and a separator 24 interposed between the positive electrode plate 21 and the negative electrode plate 25.

The positive electrode plate 21 includes a positive electrode current collector 21a, a positive electrode active material layer 21b coated on at least one surface of the positive electrode current collector 21a, and a positive electrode uncoated portion 21c at where the positive electrode active material layer 21b is not formed on the positive electrode current collector 21a. A positive electrode tab 22 is attached to the positive electrode uncoated portion 21c.

Similar to the positive electrode plate 21, the negative electrode plate 25 includes a negative electrode current collector 25a, a negative electrode active material layer 25b coated on at least one surface of the negative electrode current collector 25a, and a negative electrode uncoated portion 25c at where the negative electrode active material layer 25b is not formed on the negative electrode current collector 25a. A negative electrode tab 26 is attached to the negative electrode uncoated portion 25c.

For reference, because a winding finish end-uncoated portion surrounds (or extends around) an outer side of a jelly roll-shaped electrode assembly, the winding finish end-uncoated portion acts to protect the jelly roll electrode assembly. In addition, a winding start end-uncoated portion acts as a lead for a winding core of a winding machine to hold and roll the electrode plate when the electrode assembly is wound.

In this case, at boundaries where the positive and negative electrode tabs are drawn out from the positive electrode plate 21 and the negative electrode plate 25, insulating members 27 are wound on (e.g., are placed over) the positive and negative electrode tabs 22, 26 and have a width that is greater than those of the positive and negative electrode tabs 22, 26 to prevent a short circuit between the tabs and the oppositely-charged electrode plates.

The separator 24 is interposed between the positive electrode plate 21 and the negative electrode plate 25 may be formed to have a width that is greater than those of the positive electrode plate 21 and the negative electrode plate 25 to better prevent a short circuit between the electrode plates 21, 25.

The positive electrode plate 21, the negative electrode plate 25, and the separator 24 having the above-described structure are wound in one direction by using a winder, such as a mandrel, to form the electrode assembly as shown in FIG. 1B. Adhesive tape is attached to the outermost portion of the wound electrode assembly to prevent the wound electrode assembly from unwinding. Referring to a structure of the electrode assembly as shown in FIG. 1B, the positive electrode tab 22 of the positive electrode plate and the negative electrode tab 26 of the negative electrode plate are positioned at intervals (e.g., at predetermined intervals) in the center of the wound electrode assembly, and each end is drawn out to the outside of the electrode assembly.

A structure of the electrode assembly 100 for a secondary battery according to embodiments of the present disclosure in which at least two positive electrode tabs 112 and at least two negative electrode tabs 132 protrude upwardly and downwardly, respectively, from the electrode assembly 100, is differentiated from the structure of the electrode assembly structure according to the related art shown in FIGS. 1A and 1B. For example, at least two positive electrode tabs 112 may be formed to protrude upwardly from an upper portion of the electrode assembly 100 and at least two negative electrode tabs 132 may be formed to protrude downwardly from a lower portion of the electrode assembly 100. In another embodiment, at least two positive electrode tabs 112 may be formed to protrude downwardly from the lower portion of the electrode assembly, and at least two negative electrode tabs 132 may be formed to protrude upwardly from the upper portion of the electrode assembly.

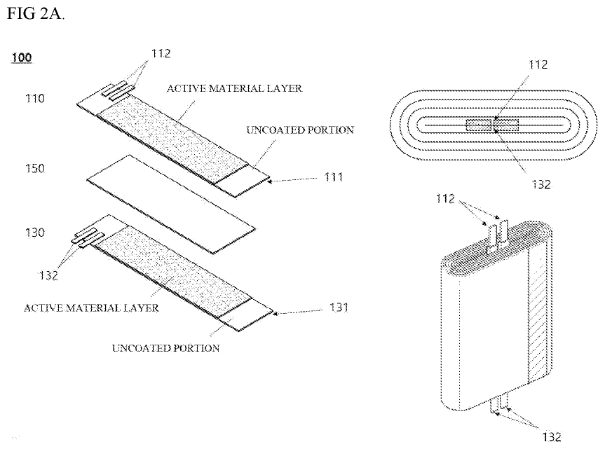

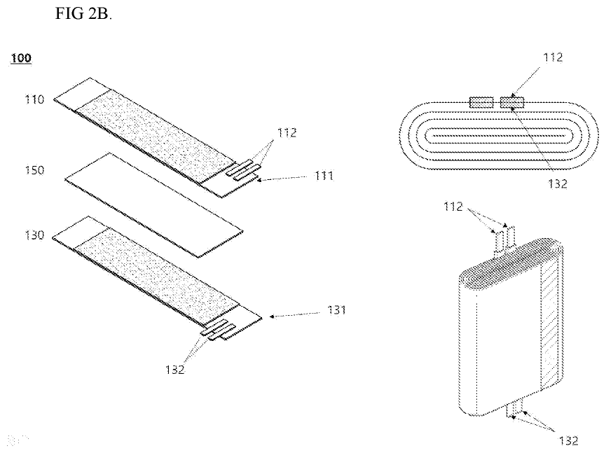

Hereinafter, the electrode assembly 100 according to an embodiment of the present disclosure will be described, in detail, with reference to FIG. 2A.

Referring to FIG. 2A, the electrode assembly 100 according to an embodiment of the present disclosure includes a positive electrode plate 110 having a positive electrode current collector plate 111 and a positive electrode active material layer formed on at least one surface of the positive electrode current collector plate 111, a negative electrode plate 130 having a negative electrode current collector plate 131 and a negative electrode active material layer formed on at least one surface of the negative electrode plate 130, and a separator 150 interposed between the positive electrode plate 110 and the negative electrode plate 130 to insulate the electrode plates 111, 131 from each other.

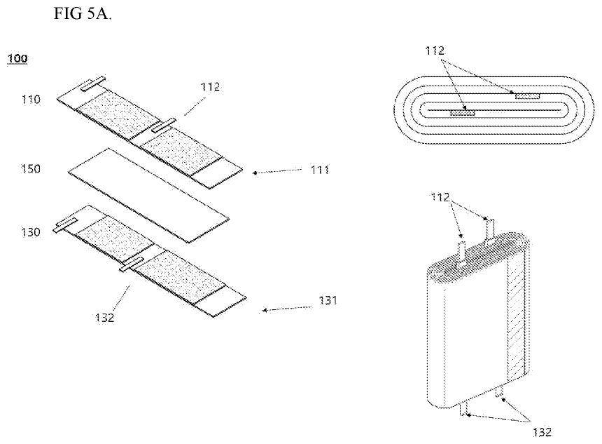

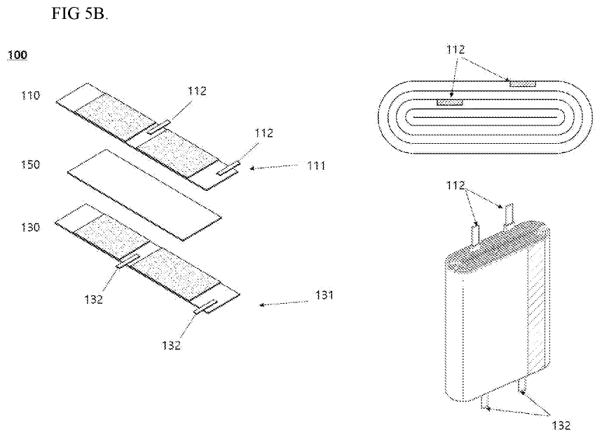

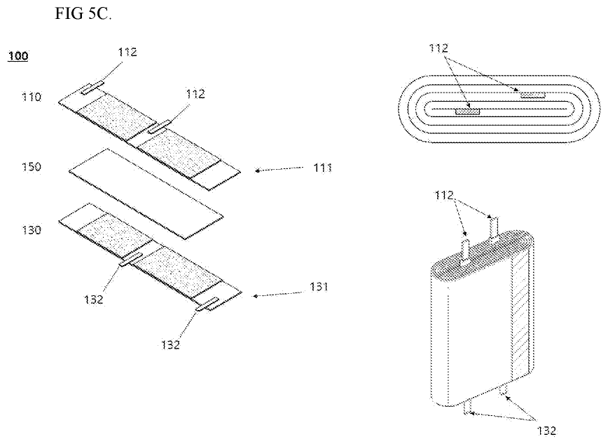

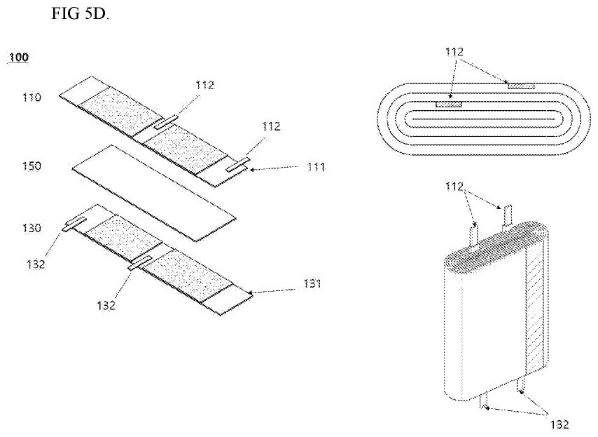

In this embodiment, at least one uncoated portion at where no positive electrode active material is applied is provided on the positive electrode plate 110, and at least one uncoated portion at where no negative electrode active material is applied is provided on the negative electrode plate 130. For example, as shown in FIG. 2A, the positive electrode active material is applied in an area excluding both (or opposite) end areas (e.g., winding start and finish areas) in a winding direction of the positive electrode plate 110, and thus, uncoated portions are provided at both ends of the positive electrode plate 110. In addition, in the negative electrode plate 130, the negative electrode active material is applied in an area excluding both (or opposite) end areas in a winding direction of the negative electrode plate 130, and thus, uncoated portions are provided at both ends of the negative electrode plate 130. In another embodiment, as shown in FIG. 5A, the uncoated portions may be provided not only at winding start ends and winding finish ends in the winding direction of the positive electrode plate 110 and the negative electrode plate 130 but also at the center thereof between the uncoated portions.

The electrode tab(s) may be bonded to an area at where a portion of the electrode plate is exposed, that is, the uncoated portion, by using a method such as welding. For example, at least two positive electrode tabs 112 are electrically attached and coupled to at least one of the uncoated portions of the positive electrode plate 110, and at least two negative electrode tabs 132 are electrically attached and coupled to at least one of the uncoated portions of the negative electrode plate 130. In this embodiment, positive electrode tabs 112 protrude upwardly from the upper portion of the electrode assembly 100, and the negative electrode tabs 132 protrude downwardly from the lower portion of the electrode assembly 100. That is, when the positive electrode plate 110, the separator 150, and the negative electrode plate 130 are prepared and then wound by using a separately provided winder, as shown in the lower right portion of FIG. 2A, portions of the positive electrode tabs 112 protrude upwardly from the wound electrode assembly 100, and portions of the negative electrode tabs 132 protrude downwardly from the wound electrode assembly 100.

According to the above-described configuration of the electrode assembly 100, when the electrode assembly 100 is accommodated in a space of a pouch exterior material to prepare a unit battery cell, because the electrode tabs protrude to be exposed in opposite directions of the pouch exterior material, that is, upwardly and downwardly, an electrical connection between the electrode tabs is relatively easy when a plurality of battery cells are arranged (or connected) in series. Additionally, when a plurality of battery cells are connected in series, positions of the positive electrode tabs 112 and the negative electrode tabs 132 in one battery cell may be set to correspond to each other to allow the electrode tabs to be arranged and connected to corresponding electrode tabs of an adjacent battery cell at the shortest distance. That is, both the positive electrode tabs 112 and the negative electrode tabs 132 may be provided at the winding start end of the electrode plates or the winding finish end of the winding end of the electrode plates. In such an embodiment, because the position of the electrode tab in the wound electrode assembly 100 is disposed close to a position of an electrode tab of an adjacent battery cell, work to electrically connect the electrode tabs can be easily performed.

Hereinafter, the electrode assembly 100 according to various other embodiments of the present disclosure will be described, in detail, with reference to FIGS. 2A to 6.

Referring again to FIG. 2A, a pair of positive electrode tabs 112 are provided in an uncoated portion at a winding start end of a positive electrode plate 110 in the winding direction, and a pair of negative electrode tabs 132 are provided in an uncoated portion at a winding start end of a negative electrode plate 130 in the winding direction According to the above-described structural features, as shown on the right side of FIG. 2A, both the positive electrode tabs 112 and the negative electrode tabs 132 are provided inside (e.g., near or at the center of) the electrode assembly 100.

FIG. 2B is a set of an exploded perspective view and a wound cross-sectional view of an electrode assembly 100 according to another embodiment of the present disclosure. Referring to the drawing, a pair of positive electrode tabs 112 are provided in an uncoated portion at a winding finish end of a positive electrode plate 110 in the winding direction, and a pair of negative electrode tabs 132 are provided in an uncoated portion at a winding finish end of a negative electrode plate 130 in the winding direction According to the above-described structural features, as shown on the right side of FIG. 2B, both the positive electrode tabs 112 and the negative electrode tabs 132 are provided on the outside of the electrode assembly 100.

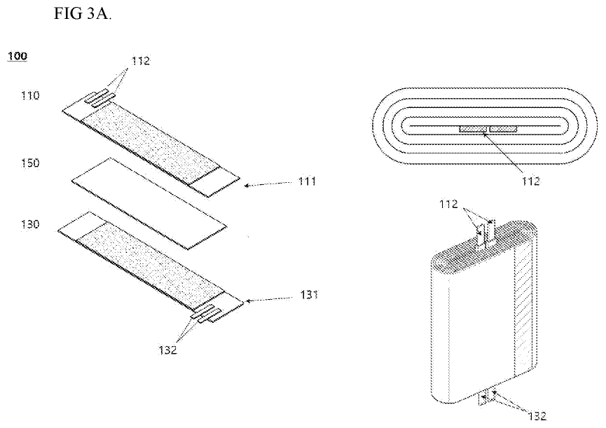

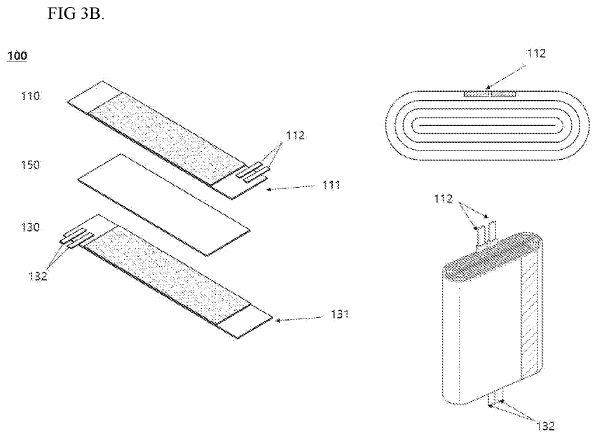

FIGS. 3A and 3B are an exploded perspective view and a wound cross-sectional view of an electrode assembly according to modified examples of the embodiments shown in FIGS. 2A and 2B, respectively. Referring to FIG. 3A, a pair of positive electrode tabs 112 are provided in an uncoated portion at a winding start end of a positive electrode plate 110 in the winding direction, and a pair of negative electrode tabs 132 are provided in an uncoated portion at a winding finish end of a negative electrode plate 130 in the winding direction. According to the above-described structural features, the positive electrode tabs 112 are provided inside the electrode assembly 100, and the negative electrode tabs 132 are provided on the outside of the electrode assembly 100.

Referring to FIG. 3B, a pair of positive electrode tabs 112 are provided in an uncoated portion at a winding finish end of the positive electrode plate 110 in the winding direction, and a pair of negative electrode tabs 132 are provided in an uncoated portion at a winding start end of a negative electrode plate 130 in the winding direction. According to the above-described structural features, the positive electrode tabs 112 are provided on the outside of the electrode assembly 100, and the negative electrode tabs 132 are also provided inside the electrode assembly 100.

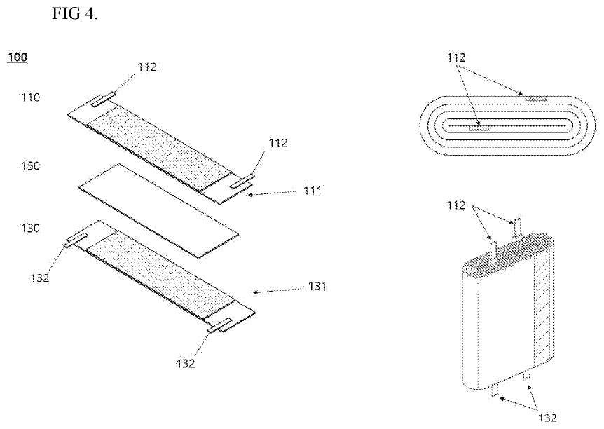

FIG. 4 is a set of an exploded perspective view and a wound cross-sectional view of an electrode assembly 100 according to another embodiment of the present disclosure. Referring to the drawing, positive electrode tabs 112 are respectively provided in uncoated portions at a winding start end and a winding finish end of a positive electrode plate 110 in the winding direction, and negative electrode tabs 132 are respectively provided in uncoated portions at a winding start end and a winding finish end of the negative electrode plate 130 in the winding direction. According to the above-described structural features, as shown on the right side of FIG. 4, the positive electrode tabs 112 are provided inside and on the outside of the electrode assembly 100, and the negative electrode tabs 132 are also provided inside and on the outside of the electrode assembly 100. According to the above-described configuration, the electrode tabs are applied to both the winding start ends and the winding finish ends of the electrode plates so that resistance is reduced.

For reference, in the embodiment shown in FIG. 4, the positive electrode tabs and the negative electrode tabs may be disposed to overlap in the electrode assembly after the winding, and in such an embodiment, a base tab may be first welded to each electrode plate and an S/T (strip terminal) may be additionally welded secondarily.

FIG. 5A is a set of an exploded perspective view and a wound cross-sectional view of the electrode assembly 100 according to another embodiment of the present disclosure. Referring to the drawing, uncoated portions are provided at winding start ends, winding finish ends, and centers of a positive electrode plate 110 and a negative electrode plate 130 in the winding direction. Positive electrode tabs 112 are provided in the uncoated portions at the winding start end and the center of the positive electrode plate 110 in the winding direction, and negative electrode tabs 132 are provided in the uncoated portions at the winding start end and the center of the negative electrode plate 130 in the winding direction. According to the above-described structural features, as shown on the right side of FIG. 5A, the positive electrode tabs 112 and the negative electrode tabs 132 are provided at intermediate positions between the inside and the outside of the electrode assembly 100 and at the inside thereof.

FIG. 5B is a set of an exploded perspective view and a wound cross-sectional view of an electrode assembly according to another embodiment of the present disclosure. Referring to the drawing, uncoated portions are provided at winding start ends, winding finish ends, and centers of a positive electrode plate 110 and a negative electrode plate 130 in the winding direction. Positive electrode tabs 112 are provided in the uncoated portions at the center and the winding finish end of the positive electrode plate 110 in the winding direction, and negative electrode tabs 132 are provided in the uncoated portions at the center and the winding finish end of the negative electrode plate 130 in the winding direction. According to the above-described structural features, as shown on the right side of FIG. 5B, the positive electrode tabs 112 and the negative electrode tabs 132 are provided at intermediate positions between the inside and the outside of the electrode assembly 100 and at the outside thereof.

FIGS. 5C and 5D are an exploded perspective view and a wound cross-sectional view of an electrode assembly according to modified examples of the embodiments shown in FIGS. 5A and 5B, respectively. Referring to FIG. 5C, positive electrode tabs 112 are provided in uncoated portions at a winding start end and a center of a positive electrode plate 110 in the winding direction, and negative electrode tabs 132 are provided in uncoated portions at a center and a winding finish end of a negative electrode plate 130 in the winding direction.

Referring to FIG. 5D, the positive electrode tabs 112 are provided in uncoated portions at the center and a winding finish end of the positive electrode plate 110 in the winding direction, and the negative electrode tabs 132 are provided in uncoated portions at a winding start end and the center of the negative electrode plate 130 in the winding direction.

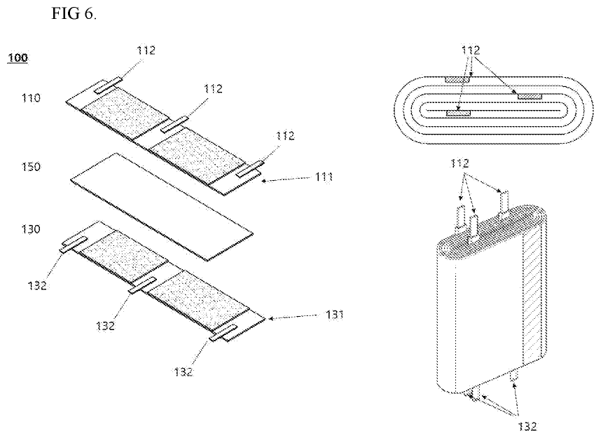

FIG. 6 is a set of an exploded perspective view and a wound cross-sectional view of an electrode assembly 100 according to another embodiment of the present disclosure. Referring to the drawing, uncoated portions are provided at winding start ends, winding finish ends, and centers between the uncoated portion of a positive electrode plate 110 and a negative electrode plate 130 in the winding direction. Positive electrode tabs 112 are provided at the winding start end, the winding finish end, and the center of the positive electrode plate 110, and negative electrode tabs 132 are provided at the winding start end, the winding finish end, and the center of the negative electrode plate 130. According to the above-described structural features, as shown on the right side of FIG. 6, the positive electrode tabs 112 are provided at positions inside and outside of the electrode assembly 100 and a position at the center of the electrode assembly 100, and the negative electrode tabs 132 are provided at positions inside and outside of the electrode assembly 100 and a position at the center of the electrode assembly 100. According to the above-described configuration, the electrode tabs are applied to both the winding start ends and the winding finish ends of the electrode plates to reduce resistance.

As described above, according to various embodiments of the present disclosure, because the connection between the electrode tabs is relatively easy when a plurality of battery cells are connected in series, a battery pack capable of exhibiting high voltage and high output can be easily constructed. That is, a high-voltage and high-output battery pack can be easily provided by connecting battery cells of individual units together in series.

According to embodiments of the present disclosure, because electrode tabs are formed to protrude from an electrode assembly in two directions, connection between the electrode tabs is relatively easy when a plurality of battery cells are connected together in series and a battery pack capable of exhibiting high voltage and high output can be easily constructed.

What has been described above are merely some embodiments for implementing an electrode assembly for a secondary battery according to the present disclosure, and the present disclosure is not limited to the above embodiments. As described in the appended claims and their equivalents, the technical spirit of the present disclosure will be considered to the extent that various modifications can be made by anyone skilled in the art without departing from the gist of the present disclosure.

1 What is claimed is:

1. An electrode assembly for a secondary battery, the electrode assembly comprising:
a positive electrode plate comprising:
a positive electrode current collector plate and having a positive electrode active material layer on a surface of the positive electrode current collector plate and at least one uncoated portion at where no positive electrode active material is applied; and
a plurality of positive electrode tabs electrically attached and coupled to the uncoated portions;
a negative electrode plate comprising:
a negative electrode current collector plate and having a negative electrode active material layer on a surface of the negative electrode current collector plate and at least one uncoated portion at where no negative electrode active material is applied; and
a plurality of negative electrode tabs electrically attached and coupled to the uncoated portions; and
a separator between the positive electrode plate and the negative electrode plate to insulate the positive and negative electrode plates from each other,
wherein the positive electrode tabs protrude upwardly from an upper portion of the electrode assembly, and the negative electrode tabs protrude downwardly from a lower portion of the electrode assembly.

2. The electrode assembly of claim 1, wherein:
the uncoated portions of the positive electrode plate are provided at a winding start end and a winding finish end of the positive electrode plate in a winding direction, and
the uncoated portions of the negative electrode plate are provided at a winding start end and a winding finish end of the negative electrode plate in a winding direction, and
a pair of the positive electrode tabs are provided at the uncoated portion of the positive electrode plate at the winding start end of the positive electrode plate in the winding direction, and a pair of the negative electrode tabs are provided at the uncoated portion of the negative electrode plate at the winding start end of the negative electrode plate in the winding direction.

3. The electrode assembly of claim 1, wherein:
the uncoated portions are provided at a winding start end and a winding finish end of the positive electrode plate in a winding direction,
the uncoated portions are provided at a winding start end and a winding finish end of the negative electrode plate in a winding direction, and
a pair of the positive electrode tabs are provided at the uncoated portion of the positive electrode plate at the winding finish end of the positive electrode plate in the winding direction, and a pair of the negative electrode tabs are provided at the uncoated portion of the negative electrode plate at the winding finish end of the negative electrode plate in the winding direction.

4. The electrode assembly of claim 1, wherein:
the uncoated portions are provided at a winding start end and a winding finish end of the positive electrode plate in a winding direction,
the uncoated portions are provided at winding start end and winding finish end of the negative electrode plate in a winding direction, and
the positive electrode tabs are provided at the uncoated portion of the positive electrode plate at the winding start end and the winding finish end of the positive electrode plate in the winding direction, and the negative electrode tabs are provided at the uncoated portions of the negative electrode plate at the winding start end and the winding finish end of the negative electrode plate in the winding direction.

5. The electrode assembly of claim 1, wherein:
the uncoated portions are provided at a winding start end, a winding finish end. and a center between the uncoated portions of the positive electrode plate in a winding direction,
the uncoated portions are provided at a winding start end, a winding finish end, and a center between the uncoated portions of the negative electrode plate in a winding direction,
the positive electrode tabs are provided at the uncoated portion of the positive electrode plate at the winding start end and the center of the positive electrode plate in the winding direction, and
the negative electrode tabs are provided in the uncoated portion of the negative electrode plate at the winding start end and the center of the negative electrode plate in the winding direction.

6. The electrode assembly of claim 1, wherein:
the uncoated portions are provided at a winding start end, a winding finish end, and a center between the uncoated portions of the positive electrode plate in a winding direction,
the uncoated portions are provided at a winding start end, a winding finish end, and a center between the uncoated portions of the negative electrode plate in a winding direction,
the positive electrode tabs are provided at the uncoated portions of the positive electrode plate at the winding start end, the winding finish end, and the center of the positive electrode plate in the winding direction,
the negative electrode tabs are provided at the uncoated portions of the negative electrode plate at the winding start end, the winding finish end, and the center of the negative electrode plate in the winding direction.
